(19) United States
(12) Patent Application Publication
(10) Pub. No.: US 2015/0219531 A1
(43) Pub. Date: Aug. 6, 2015

(54) EXTRACTION APPARATUS AND METHOD

(71) Applicants: CAMBTEK LIMITED, Melbourn, Hertfordshire (GB); PA KNOWLEDGE LIMITED, London (GB)

(72) Inventors: Anthony Hawkins, Cambridge Cambridgeshire (GB); Thomas Watt, St Ives (GB); Colin Turner, Cambridge Cambridgeshire (GB); Jonathan Howells, Bishop's Stortford Hertfordshire (GB); Hugh Malkin, Cottenham Cambridgeshire (GB); Graham Gutsell, Newbury Berkshire (GB); Nicholas Hastings, Fen Drayton Cambridgeshire (GB); Nicholas Mounteney, Huntington (GB)

(73) Assignees: PA KNOWLEDGE LIMITED, London, (US); CAMBTEK LIMITED, Melbourn Hertfordshire, (GB)

(21) Appl. No.: 14/424,877

(22) PCT Filed: Jul. 30, 2013
(86) PCT No.: PCT/GB2013/052032

§ 371 Date: Feb. 27, 2015

(30) Foreign Application Priority Data
Aug. 31, 2012 (GB) 1215514.9
Aug. 31, 2012 (GB) 1215515.6
Aug. 31, 2012 (GB) 1215516.4
Aug. 31, 2012 (GB) 1215518.0

(51) Int. Cl. G01N 1/14

(52) U.S. Cl. CPC G01N 1/14

(57) ABSTRACT

Disclosed is apparatus for distributing a solid, gel, powder or viscous test substance in an extraction fluid, the apparatus comprising a flow cell for holding the test substance and having an inlet and an outlet; an extraction chamber located between said inlet and outlet comprising a convergent nozzle; and a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet; characterized in that the apparatus further comprises a tortuous path flow control valve (TPV) located at the outlet and configured to permit flow of extraction fluid and extracted test substance but to prevent or retard passage of said test substance through the outlet.

### FIELD OF THE INVENTION

The invention relates to apparatus and kits for distributing, dissolving and/or suspending a solid, gel, powder or viscous test substance in an extraction fluid, as well as to methods for distributing, dissolving and/or suspending a test substance in an extraction fluid and processes for producing extracted test products using such methods.

### BACKGROUND TO THE INVENTION

Dissolution or extraction of drug dosage forms is routinely used in drug quality control (e.g. to assess batch-to-batch consistency of solid oral dosage forms such as tablets) as well as in drug development (e.g. to predict in vivo drug release dynamics).

WO 2010/020752 describes an apparatus for the rapid extraction of drug dosage forms, including tablets, gels and powders. The apparatus includes a flow cell for holding the test substance and having an inlet and an outlet; an extraction chamber located between said inlet and outlet comprising a convergent nozzle; and a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet.

The apparatus described in WO 2010/020752 describes the use of grooves within the extraction chamber to inhibit blockage and to create turbulent flow. As described in WO 2010/020752, the walls defining the internal passageway of the extraction region may have a shape defining a plurality of grooves side by side around the internal passageway, each one of the grooves extending at least partly from the upstream end to the downstream end. WO 2010/020752 teaches that the grooves are very effective in allowing the extraction fluid to continue flowing and create additional powerful turbulence that increases extraction rate, and that they can inhibit the test product from blocking up the extraction region and be effective in creating turbulence and vortices which assist in breaking up the test product. Thus, WO 2010/020752 discloses that a single set/plurality of grooves can be provided along the entire length of the extraction region and that preferably, adjacent to the upstream end, a first plurality of said grooves are provided and, adjacent the downstream end, a second plurality of said grooves are provided, so allowing different effects to be achieved at different portions along the length of the extraction region.

It has now been recognized that the performance of the apparatus as described in WO 2010/020752 (the content of which is hereby incorporated by reference) can be greatly improved by: (a) incorporating a tortuous path flow control valve (TPV) at the outlet of the flow cell; or (b) incorporating a nozzle throat constrictor; or (c) incorporating a pressure sensor for monitoring the pressure within the flow path of the extraction fluid; or (d) incorporating a vented spike at the outlet of the flow cell, and that the incorporation of a vented spike eliminates the need for grooves within the extraction chamber.

### SUMMARY OF THE INVENTION

### 1. TPV Invention

In a first aspect there is provided an apparatus for distributing a solid, gel, powder or viscous test substance in an extraction fluid, the apparatus comprising:

(a) a flow cell for holding the test substance and having an inlet and an outlet;

(b) an extraction chamber located between said inlet and outlet comprising a convergent nozzle; and
(c) a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet;
   characterized in that the apparatus further comprises a tortuous path flow control valve (TPV) located at the outlet and configured to permit flow of extraction fluid and extracted test substance but to prevent or retard passage of said test substance through the outlet.

The bend(s) in the fluid flow paths imposed by the TPV of the invention are configured such that, in use, they act as a restraint against (i.e. they prevent or retard) gravity-driven fall of test product through the outlet of the apparatus during loading of the apparatus with test product and prior to the initiation of extraction with pressurized extraction fluid. This greatly facilitates loading of the apparatus with sample and prevents loss and/or system contamination.

In preferred embodiments, the TPV is configured such that, in use, it increases the pressure differential across the flow cell (e.g. by reducing the effective throat of the convergent nozzle). In this way, the time required for extraction can be reduced.

Any solid, gel, powder or viscous test substance may be distributed (e.g. dissolved and/or suspended) according to the invention, including but not limited to drug samples (including pharmaceutical solid dose forms), environmental samples, cosmetics, herbal extracts, laboratory reagents and food samples.

Other aspects of this invention are as defined in the claims appended hereto.

### 2. Throat Constrictor Invention

In a first aspect there is provided an apparatus for distributing a solid, gel, powder or viscous test substance in an extraction fluid, the apparatus comprising:
(d) a flow cell for holding the test substance and having an inlet and an outlet;
(e) an extraction chamber located between said inlet and outlet comprising a convergent nozzle; and
(f) a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet;
   characterized in that the apparatus further comprises a nozzle throat constrictor which, in use, increases the pressure differential across the flow cell by reducing the effective throat of the convergent nozzle. Without wishing to be bound by any theory, it is believed that the velocity of fluid flow through the outlet is thereby increased and the time required for extraction reduced.

In a second aspect there is provided a kit comprising:
(a) a flow cell for holding a solid, gel, powder or viscous test substance in an extraction fluid and having an inlet and an outlet;
(b) an extraction chamber located between said inlet and outlet comprising a convergent nozzle;
(c) a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet; and
(d) a separate nozzle throat constrictor which, in use, increases the pressure differential across the flow cell by reducing the effective throat of the convergent nozzle.

The nozzle throat constrictor may take the form of a tortuous path flow control valve (TPV) located at the outlet. In such embodiments, the bend(s) in the fluid flow paths imposed by the TPV may be configured such that, in use, they act as a restraint against (i.e. they prevent or retard) gravity-driven fall of test product through the outlet of the apparatus during loading of the apparatus with test product and prior to the initiation of extraction with pressurized extraction fluid. This greatly facilitates loading of the apparatus with sample and prevents loss and/or system contamination.

Any solid, gel, powder or viscous test substance may be distributed (e.g. dissolved and/or suspended) according to the invention, including but not limited to drug samples (including pharmaceutical solid dose forms), environmental samples, cosmetics, herbal extracts, laboratory reagents and food samples.

Other aspects of this invention are as defined in the claims appended hereto.

### 3. Pressure Sensor Invention

In a first aspect there is provided an apparatus for distributing a solid, gel, powder or viscous test substance in an extraction fluid, the apparatus comprising:
(g) a flow cell for holding the test substance and having an inlet and an outlet;
(h) an extraction chamber located between said inlet and outlet comprising a convergent nozzle; and
(i) a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet;
   characterized in that the apparatus further comprises a pressure sensor for monitoring the pressure within the flow path of the extraction fluid.

The pressure sensor may be used to monitor the progress of the extraction, since the presence of particulate/incompletely extracted test product acts to increase the resistance to flow through the flow cell. Thus, the invention exploits the fact that the system pressure is relatively higher at the start of an extraction, falling when the test product is distributed in the extraction fluid.

Any solid, gel, powder or viscous test substance may be distributed (e.g. dissolved and/or suspended) according to the invention, including but not limited to drug samples (including pharmaceutical solid dose forms), environmental samples, cosmetics, herbal extracts, laboratory reagents and food samples. The term “pharmaceutical solid dose form” is used herein to define a pharmaceutical composition in the form of a solid, gel, slurry or viscous liquid.

Other aspects of this invention are as defined in the claims appended hereto.

### 4. Vented Spike Invention

In a first aspect there is provided an apparatus for distributing a solid, gel, powder or viscous test substance in an extraction fluid, the apparatus comprising:
(j) a flow cell for holding the test substance and having an inlet and an outlet;
(k) an extraction chamber located between said inlet and outlet comprising a convergent nozzle; and
(l) a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet;
   characterized in that the apparatus further comprises a vented spike located at the nozzle throat and configured to permit flow of extraction fluid and extracted test substance but to prevent or reduce blockage of the outlet by unextracted or partially extracted test substance during extraction.

The vented spike of the invention may comprise a device which extends along a longitudinal axis from the nozzle throat into the extraction chamber such that access of unextracted or partially extracted test substance fragments that are larger than the nozzle throat (and so capable of blocking flow of extracted test substance therethrough) is selectively prevented or limited, while flow of extracted test substance through the nozzle throat and outlet is permitted by vents.

The spike may therefore take the form of a substantially rod-shaped body having a longitudinal axis extending from the nozzle throat into the extraction chamber and having a relatively small cross-sectional area at the outlet-distal (i.e. inlet-proximal) end. Thus, the outlet-distal end may be substantially domed, rounded, pointed, chamfered and/or tapered. Tapers may be one or more step-taper(s) or a continuous taper. The outlet-distal end may therefore comprise a dome, hemispheric, spherical cap, cone or frusto-conical element.

For example, the outlet-distal end of the rod may terminate in a substantially hemispherical end face. Alternatively, or in addition, the outlet-distal end face may comprise an annular chamfer, the chamfer being an angled annular cut formed between the side surface and the end face. Such rod-shaped spikes may be radially symmetrical. Alternatively, they may be radially asymmetrical.

In one embodiment, the spike takes the form of a single step-tapered rod comprising an annular chamfer formed on the side surface and step face, the end face being substantially hemispherical.

The spike may be hollow, in whole or in part. The rod may be substantially circular in cross section, or may be polygonal in cross section. For example, the spike may be triangular or square in cross section.

The vent may comprise one or more fluid channels extending between the spike and outlet, and may take the form of one or more slits, holes or notches in the spike. Alternatively, or in addition, the vent may take the form of one or more gap(s) between the walls of the nozzle throat and the spike, said gap(s) defining one or more fluid channels extending between the spike and outlet. In such embodiments, the gap(s) may be formed by the voids between a non-circular (in cross-section) portion of a spike located within a cylindrical portion of the nozzle outlet.

In embodiments where the spike is hollow, the vent may comprise one or more channels in fluid communication with the interior of the spike, said spike interior itself being in fluid communication with the outlet.

In preferred embodiments, the vented spike forms part of a nozzle throat constrictor which, in use, increases the pressure differential across the flow cell by reducing the effective throat of the convergent nozzle. Without wishing to be bound by any theory, it is believed that the velocity of fluid flow through the outlet is thereby increased and the time required for extraction reduced.

The nozzle throat constrictor may take the form of a tortuous path flow control valve (TPV) located at the outlet. In such embodiments, the tortuous path flow control valve (TPV) may be configured to permit flow of extraction fluid and extracted test substance through the outlet but to prevent or retard passage of said test substance through the outlet.

In such embodiments, the bend(s) in the fluid flow paths imposed by the TPV may be configured such that, in use, they act as a restraint against (i.e. they prevent or retard) gravity-driven fall of test product through the outlet of the apparatus during loading of the apparatus with test product and prior to the initiation of extraction with pressurized extraction fluid. This greatly facilitates loading of the apparatus with sample and prevents loss and/or system contamination.

In some embodiments, the vented spike and/or TPV is configured such that, in use, it increases the pressure differential across the flow cell (e.g. by reducing the effective throat of the convergent nozzle). In this way, the time required for extraction can be reduced.

In other embodiments, the extraction chamber does not comprise grooves and/or ribs.

Any solid, gel, powder or viscous test substance may be distributed (e.g. dissolved and/or suspended) according to the invention, including but not limited to drug samples (including pharmaceutical solid dose forms), environmental samples, cosmetics, herbal extracts, laboratory reagents and food samples.

Other aspects of this invention are as defined in the claims appended hereto.

### DETAILED DESCRIPTION OF THE INVENTION

### I. Definitions

Where used herein and unless specifically indicated otherwise, the following terms are intended to have the following meanings in addition to any broader (or narrower) meanings the terms might enjoy in the art:

The term “pharmaceutical solid dose form” is used herein to define a pharmaceutical composition in the form of a solid, gel, slurry or viscous liquid.

The term “tortuous path flow control valve” (or “TPV”) is used herein to define a valve which comprises at least one fluid conduit, which at least one conduit defines a fluid flow path which comprises one or more bends.

The term “labyrinth control valve” is used herein to define a class of TPV which comprises at least one fluid conduit, which at least one conduit defines a fluid flow path which comprises a plurality of bends.

The term “simple labyrinth control valve” is used herein to define a subclass of labyrinth control valves which comprises a single fluid conduit which conduit defines a fluid flow path which comprises a plurality of bends.

The term “branched labyrinth control valve” is used herein to define a subclass of labyrinth control valves which comprises a branched fluid conduit, one or more branches of which define a fluid flow path which comprises a plurality of bends.

The term “reticulated labyrinth control valve” is used herein to define a subclass of labyrinth control valves which comprises one or more reticulated fluid conduit(s), the reticulated conduits defining a fluid flow path which comprises a plurality of bends.

### II. Exemplification

### 1. TPV Invention

Embodiments of this invention will now be described by way of example with reference to the accompanying drawings in which:

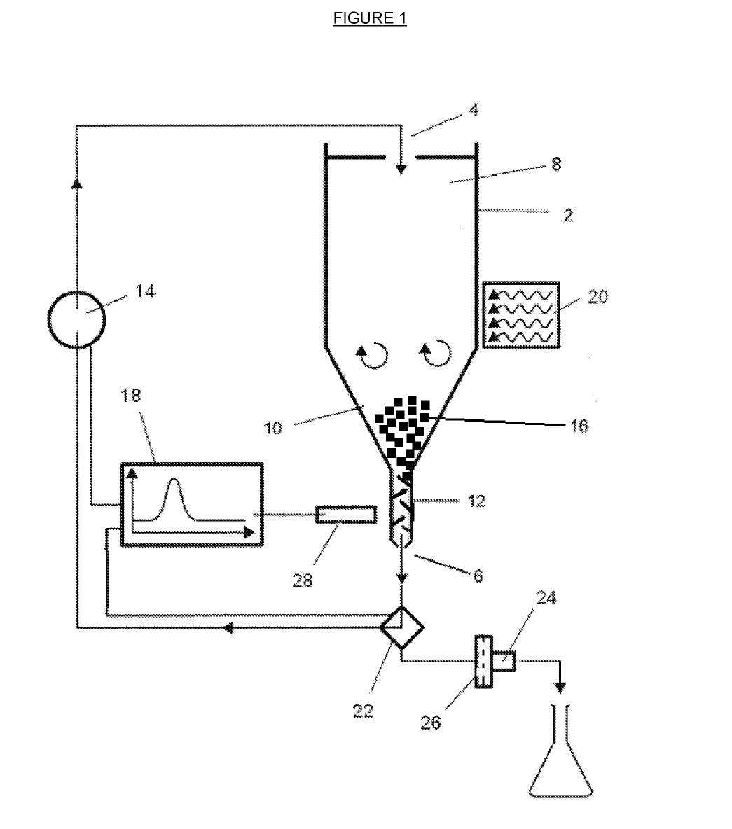

FIG. 1 illustrates schematically apparatus embodying the present invention

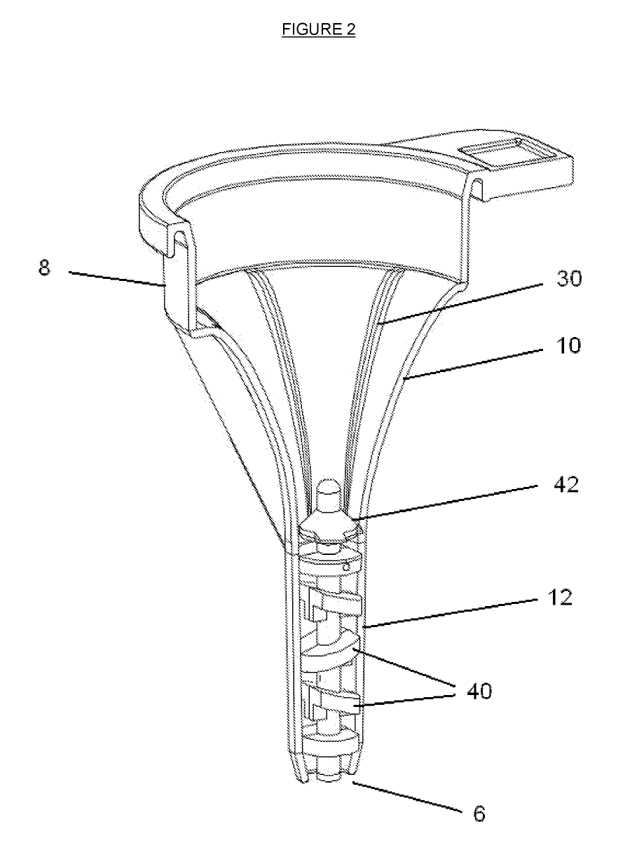

FIG. 2 is a cut-away perspective view of an extraction chamber comprising a reticulated labyrinth control valve.

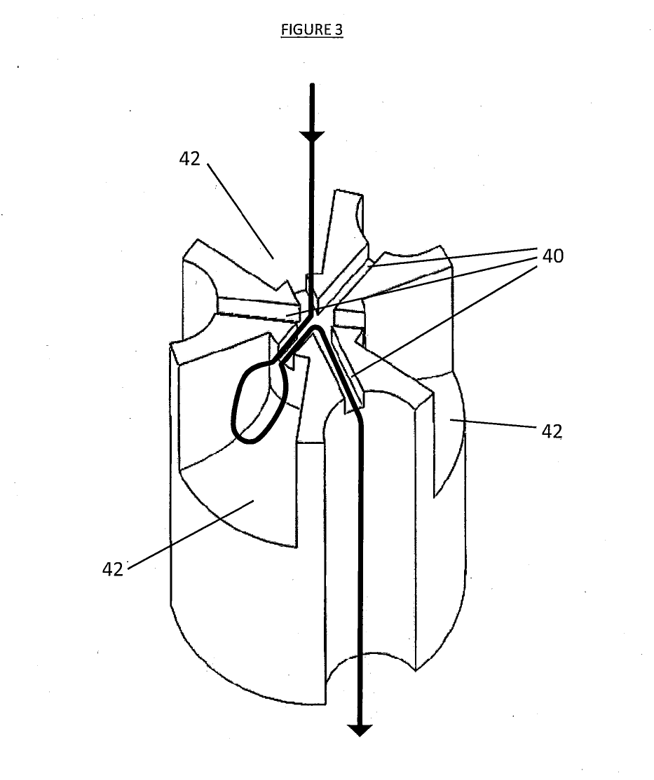

FIG. 3 is a perspective view of a branched labyrinth control valve.

Referring to FIG. 1, the apparatus includes a flow cell (2) having a fluid inlet (4) and a fluid outlet (6). Between the fluid inlet (4) and the fluid outlet (6), there is an extraction chamber (8) comprising a convergent nozzle (10). At the outlet (6) is positioned a TPV (12). Extraction fluid, for example an aqueous solvent, is driven through the flow cell (2) from the fluid inlet (4), through the extraction chamber (8) and out of the fluid outlet (6) via the TPV (12) by recirculating pump (14), and then back to the fluid inlet (4) to re-circulate the extraction fluid.

In use, a test substance (16), here a drug powder, is poured into the flow cell (2). The powder is retained in the extraction chamber (8) by TPV (12). Extraction fluid is then passed through the extraction chamber (8) by recirculating pump (14), controlled by controller (18) until the test substance (16) has been fully broken up, dissolved, suspended and/or distributed throughout the extraction fluid, for instance in solution or as a suspension.

The rapid flowing extraction fluid which flows past the test substance (16) creates turbulent flow illustrated with the curled arrows in FIG. 1. This, coupled with entrained partially extracted fragments of the test substance (16), accelerates dissolution/suspension of the test substance (16). Physical breakdown of the test substance (16) is further accelerated by an ultrasound generator (20). This may be achieved by dry or wet coupling, but preferred is the delivery of sonic energy via a sonic horn located near the inlet of the flow cell.

Also provided is a collection valve (22) which is operable to redirect the extraction fluid flow to a collection port (24) so that extracted test substance can be collected for analysis. The collection port (24) is provided with a filter (26) so that suspensions are filtered prior to collection.

A meter (28) for detecting a predetermined property of the extraction fluid is provided to determine when the test product (16) has been fully extracted. Suitable meters include turbidity meters and UV spectrophotometer probes. Controller (18) receives a signal from the meter (28) and, based on that signal, can control the pump (12) and collection valve (22).

Referring now to FIG. 2, extraction chamber (8) comprises a substantially conical convergent nozzle (10). Ribs (30) extend along the longitudinal axis of the inner walls of the convergent nozzle (10). The reticulated labyrinth control valve (12) comprises a plurality of notched cylindrical wedges (40) disposed on a spindle along the longitudinal axis of the outlet (6). Also provided is a powder/particle retaining means (42) for partitioning fragmented test substance according to size, such that larger fragments are retained nearer the inlet while smaller fragments are released towards the outlet.

In use, the notched cylindrical wedges define a reticulated labyrinthine flow path for extraction fluid and extracted test substance in which the flow path is divided by the spindle, merged and driven up over the surface of each wedge before flowing in the opposite direction via the channels between the notch in each wedge and the inner walls of the outlet (6). The wedges act as a restraint against gravity-driven fall of test product through the outlet of the apparatus during loading of the apparatus with test product and prior to the initiation of extraction with pressurized extraction fluid.

The TPV illustrated in FIG. 2 also increases the pressure differential across the flow cell by reducing the effective throat of the convergent nozzle. In this way, the time required for extraction is reduced.

An alternative TPV is shown in FIG. 3. This shows a solid insert which sits within a tube at the fluid outlet (6). The insert comprises three bent channels (40) and three blind channels (42) which act to impose a tortuous, multichannel flow path when in use (as shown schematically by the arrow).

Further details of apparatus, systems and methods for use with the TPV of the invention may be found in WO 2010/020752, the contents of which are incorporated herein by reference.

The foregoing description details presently preferred embodiments of the present invention which are therefore to be considered in all respects as illustrative and not restrictive. Those skilled in the art will recognize, or be able to ascertain, using no more than routine experimentation, many equivalents, modifications and variations to the specific embodiments of the invention described specifically herein. Such equivalents, modifications and variations are intended to be (or are) encompassed in the scope of the following claims.

### 2. Throat Constrictor Invention

Embodiments of this invention will now be described by way of example with reference to the accompanying drawings in which:

FIG. 1 illustrates schematically apparatus embodying the present invention

FIG. 2 is a cut-away perspective view of an extraction chamber comprising a reticulated labyrinth control valve.

FIG. 3 is a perspective view of a branched labyrinth control valve.

Referring to FIG. 1, the apparatus includes a flow cell (2) having a fluid inlet (4) and a fluid outlet (6). Between the fluid inlet (4) and the fluid outlet (6), there is an extraction chamber (8) comprising a convergent nozzle (10). At the outlet (6) is positioned a nozzle throat constrictor in the form of a TPV (12). Extraction fluid, for example an aqueous solvent, is driven through the flow cell (2) from the fluid inlet (4), through the extraction chamber (8) and out of the fluid outlet (6) via the TPV (12) by recirculating pump (14), and then back to the fluid inlet (4) to re-circulate the extraction fluid.

In use, a test substance (16), here a drug powder, is poured into the flow cell (2). The powder is retained in the extraction chamber (8) by TPV (12). Extraction fluid is then passed through the extraction chamber (8) by recirculating pump (14), controlled by controller (18) until the test substance (16) has been fully broken up, dissolved, suspended and/or distributed throughout the extraction fluid, for instance in solution or as a suspension.

The rapid flowing extraction fluid which flows past the test substance (16) creates turbulent flow illustrated with the curled arrows in FIG. 1. This, coupled with entrained partially extracted fragments of the test substance (16), accelerates dissolution/suspension of the test substance (16). Physical breakdown of the test substance (16) is further accelerated by an ultrasound generator (20). This may be achieved by dry or wet coupling, but preferred is the delivery of sonic energy via a sonic horn located near the inlet of the flow cell.

Also provided is a collection valve (22) which is operable to redirect the extraction fluid flow to a collection port (24) so that extracted test substance can be collected for analysis. The collection port (24) is provided with a filter (26) so that suspensions are filtered prior to collection.

A meter (28) for detecting a predetermined property of the extraction fluid is provided to determine when the test product (16) has been fully extracted. Suitable meters include turbidity meters and UV spectrophotometer probes. Controller (18) receives a signal from the meter (28) and, based on that signal, can control the pump (12) and collection valve (22).

Referring now to FIG. 2, extraction chamber (8) comprises a substantially conical convergent nozzle (10). Ribs (30) extend along the longitudinal axis of the inner walls of the convergent nozzle (10). The nozzle throat constrictor in the form of a reticulated labyrinth control valve (12) comprises a plurality of notched cylindrical wedges (40) disposed on a spindle along the longitudinal axis of the outlet (6). Also provided is a powder/particle retaining means (42) for partitioning fragmented test substance according to size, such that larger fragments are retained nearer the inlet while smaller fragments are released towards the outlet.

In use, the notched cylindrical wedges define a reticulated labyrinthine flow path for extraction fluid and extracted test substance in which the flow path is divided by the spindle, merged and driven up over the surface of each wedge before flowing in the opposite direction via the channels between the notch in each wedge and the inner walls of the outlet (6).

The TPV illustrated in FIG. 2 increases the pressure differential across the flow cell by reducing the effective throat of the convergent nozzle. In this way, the time required for extraction is reduced.

The wedges in the TPV illustrated in FIG. 2 also act as a restraint against gravity-driven fall of test product through the outlet of the apparatus during loading of the apparatus with test product and prior to the initiation of extraction with pressurized extraction fluid.

An alternative TPV is shown in FIG. 3. This shows a solid insert which sits within a tube at the fluid outlet (6). The insert comprises three bent channels (40) and three blind channels (42) which act to impose a tortuous, multichannel flow path when in use (as shown schematically by the arrow).

Further details of apparatus, systems and methods for use with the TPV of the invention may be found in WO 2010/020752, the contents of which are incorporated herein by reference.

The foregoing description details presently preferred embodiments of the present invention which are therefore to be considered in all respects as illustrative and not restrictive. Those skilled in the art will recognize, or be able to ascertain, using no more than routine experimentation, many equivalents, modifications and variations to the specific embodiments of the invention described specifically herein. Such equivalents, modifications and variations are intended to be (or are) encompassed in the scope of the following claims.

### 3. Pressure Sensor Invention

An embodiment of this invention will now be described by way of example with reference to the accompanying drawing in which:

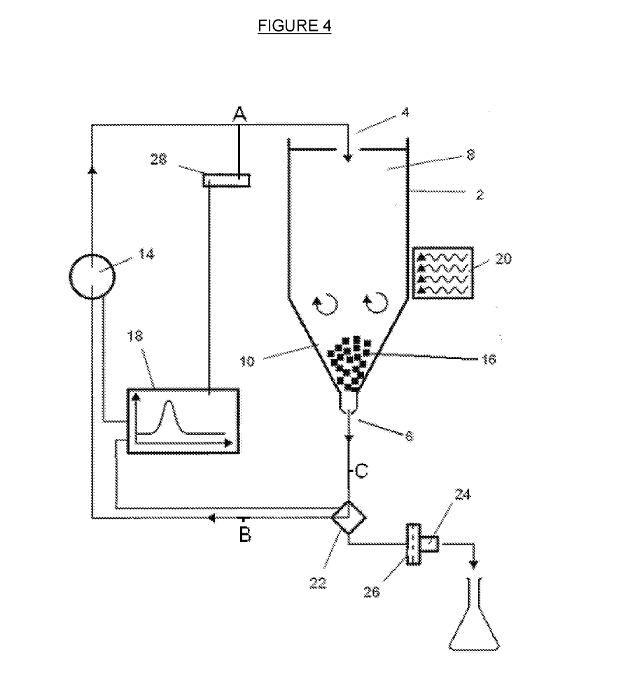

FIG. 4 illustrates schematically apparatus embodying the present invention

Referring to FIG. 4, the apparatus includes a flow cell (2) having a fluid inlet (4) and a fluid outlet (6). Between the fluid inlet (4) and the fluid outlet (6), there is an extraction chamber (8) comprising a convergent nozzle (10). Extraction fluid, for example an aqueous solvent, is driven through the flow cell (2) from the fluid inlet (4), through the extraction chamber (8) and out of the fluid outlet (6) by recirculating pump (14), and then back to the fluid inlet (4) to re-circulate the extraction fluid.

In use, a test substance (16), here a drug powder, is poured into the flow cell (2). Extraction fluid is then passed through the extraction chamber (8) by recirculating pump (14), controlled by controller (18) until the test substance (16) has been fully broken up, dissolved, suspended and/or distributed throughout the extraction fluid, for instance in solution or as a suspension.

The rapid flowing extraction fluid which flows past the test substance (16) creates turbulent flow (illustrated with the curled arrows in FIG. 4). This, coupled with entrained partially extracted fragments of the test substance (16), accelerates dissolution/suspension of the test substance (16). Physical breakdown of the test substance (16) is further accelerated by an ultrasound generator (20). This may be achieved by dry or wet coupling, but preferred is the delivery of sonic energy via a sonic horn located near the inlet of the flow cell.

Also provided is a collection valve (22) which is operable to redirect the extraction fluid flow to a collection port (24) so that extracted test substance can be collected for analysis. The collection port (24) is provided with a filter (26) so that suspensions are filtered prior to collection.

A pressure sensor (28) for monitoring the pressure within the flow path of the extraction fluid is provided to determine when the test product (16) has been fully extracted. This is shown positioned between the pump and inlet (position A in FIG. 4), but alternatively (or in addition) the pressure sensor(s) may be located at positions B and/or C as shown in FIG. 4. The use of a plurality of pressure sensors at two or more positions of the flow path may provide more detailed information on the progress of the extraction.

The output data from the pressure sensor(s) may be captured and/or monitored, and the sensor(s) may be operably linked to a monitor (not shown) for displaying, when in use, changes in pressure as an index of the progress of the extraction process.

Controller (18) receives a signal from the sensor (28) and, based on that signal, can control the pump (12) and collection valve (22).

Since the presence of particulate/incompletely extracted test product acts to increase the resistance to flow through the flow cell, system pressure is relatively higher at the start of an extraction, falling as the test product is distributed in the extraction fluid. The dynamics of this fall in system pressure may not be continuous, and in practice a series of continuous falls in pressure over time may be interrupted by one or more “spikes” of pressure increases as the test product is fragmented. Thus, any given test product may yield a more or less distinctive “signature” of system pressure changes over the course of extraction.

Thus, extraction can be monitored and controlled by:
(a) reversing the direction of the pump if the pressure within the flow path of the extraction fluid rises above a predetermined threshold; and/or
(b) clearing a blockage in the extraction fluid flow path by reversing the pump direction if the pressure within the flow path of the extraction fluid rises above a predetermined threshold; and/or
(c) switching the flow of extraction fluid from a recirculating path to a collection port if the pressure within the flow path of the extraction fluid falls to a predetermined threshold; and/or
(d) analysing the signal output from the pressure to determine when the test substance is distributed in the extraction fluid; and/or
(e) slowing the pump and switch the collection valve from a recirculating path to a collection port when it is determined that the test product is distributed in the extraction fluid; and/or
(f) displaying changes in pressure as an index of the progress of the extraction process via a monitor operably linked to the pressure sensor.

Further details of apparatus, systems and methods for use with the apparatus of the invention may be found in WO 2010/020752, the contents of which are incorporated herein by reference.

The foregoing description details presently preferred embodiments of the present invention which are therefore to be considered in all respects as illustrative and not restrictive. Those skilled in the art will recognize, or be able to ascertain, using no more than routine experimentation, many equivalents, modifications and variations to the specific embodiments of the invention described specifically herein. Such equivalents, modifications and variations are intended to be (or are) encompassed in the scope of the following claims.

### 4. Vented Spike Invention

Embodiments of this invention will now be described by way of example with reference to the accompanying drawings in which:

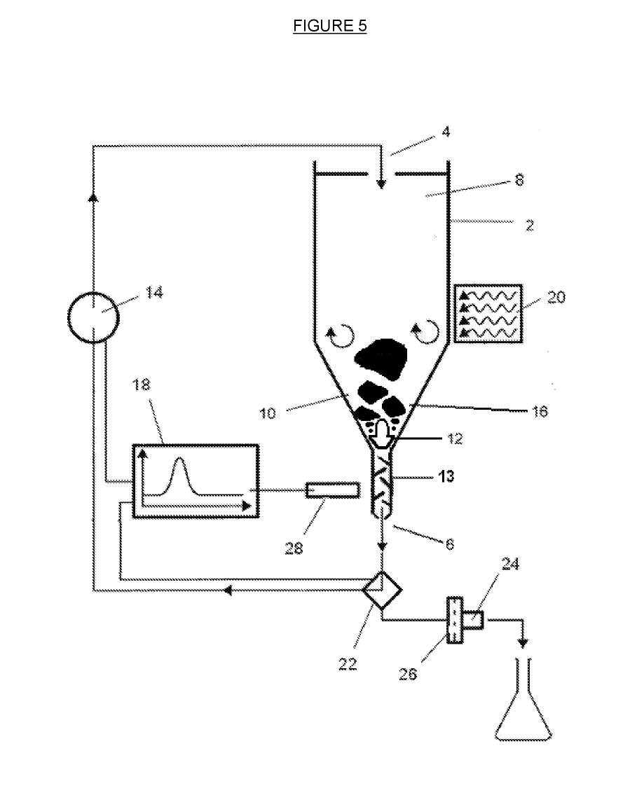

FIG. 5 illustrates schematically apparatus embodying the present invention

FIG. 2 is a cut-away perspective view of an extraction chamber comprising a vented spike and a reticulated labyrinth control valve configured as a unitary assembly.

FIG. 3 is a perspective view of a branched labyrinth control valve.

Referring to FIG. 5, the apparatus includes a flow cell (2) having a fluid inlet (4) and a fluid outlet (6). Between the fluid inlet (4) and the fluid outlet (6), there is an extraction chamber (8) comprising a convergent nozzle (10). At the outlet (6) is positioned a vented spike (12) and a TPV (13). Extraction fluid, for example an aqueous solvent, is driven through the flow cell (2) from the fluid inlet (4), through the extraction chamber (8) and out of the fluid outlet (6) via the vents in the spike (12) and the fluid conduits in the TPV (12) by recirculating pump (14), and then back to the fluid inlet (4) to re-circulate the extraction fluid.

In use, a test substance (16), here a partly extracted, fragmented, solid tablet, is placed into the flow cell (2). Extraction fluid is then passed through the extraction chamber (8) by recirculating pump (14), controlled by controller (18) until the test substance (16) has been fully broken up, dissolved, suspended and/or distributed throughout the extraction fluid, for instance in solution or as a suspension.

The rapid flowing extraction fluid which flows past the test substance (16) creates turbulent flow illustrated with the curled arrows in FIG. 5. This, coupled with entrained partially extracted fragments of the test substance (16), accelerates dissolution/suspension of the test substance (16). Physical breakdown of the test substance (16) is further accelerated by an ultrasound generator (20). This may be achieved by dry or wet coupling, but preferred is the delivery of sonic energy via a sonic horn located near the inlet of the flow cell.

Also provided is a collection valve (22) which is operable to redirect the extraction fluid flow to a collection port (24) so that extracted test substance can be collected for analysis. The collection port (24) is provided with a filter (26) so that suspensions are filtered prior to collection.

A meter (28) for detecting a predetermined property of the extraction fluid is provided to determine when the test product (16) has been fully extracted. Suitable meters include turbidity meters and UV spectrophotometer probes. Controller (18) receives a signal from the meter (28) and, based on that signal, can control the pump (12) and collection valve (22).

Referring now to FIG. 2, extraction chamber (8) comprises a substantially conical convergent nozzle (10). The reticulated labyrinth control valve (12) comprises a plurality of notched cylindrical wedges (40) disposed on a spindle along the longitudinal axis of the outlet (6). Also provided is a vented spike (42) for partitioning fragmented test substance according to size, such that larger fragments are retained nearer the inlet while smaller fragments are released towards the outlet.

Also shown are ribs (30) extending along the longitudinal axis of the inner walls of the convergent nozzle (10) defining grooves therein. These ribs/grooves may be dispensed with, since the inventors have found that the vented spike (42) prevents or reduces blockage of the outlet even in the absence of ribs and/or grooves in the inner walls of the extraction chamber.

In use, the notched cylindrical wedges define a reticulated labyrinthine flow path for extraction fluid and extracted test substance in which the flow path is divided by the spindle, merged and driven up over the surface of each wedge before flowing in the opposite direction via the channels between the notch in each wedge and the inner walls of the outlet (6). The wedges act as a restraint against gravity-driven fall of test product through the outlet of the apparatus during loading of the apparatus with test product and prior to the initiation of extraction with pressurized extraction fluid.

The vented spike-TPV illustrated in FIG. 2 also increases the pressure differential across the flow cell by reducing the effective throat of the convergent nozzle. In this way, the time required for extraction is reduced.

An alternative TPV is shown in FIG. 3 This shows a solid insert which sits within a tube at the fluid outlet (6). The insert comprises three bent channels (40) and three blind channels (42) which act to impose a tortuous, multichannel flow path when in use (as shown schematically by the arrow).

Further details of apparatus, systems and methods for use with the vented spike of the invention may be found in WO 2010/020752, the contents of which are incorporated herein by reference.

The foregoing description details presently preferred embodiments of the present invention which are therefore to be considered in all respects as illustrative and not restrictive. Those skilled in the art will recognize, or be able to ascertain, using no more than routine experimentation, many equivalents, modifications and variations to the specific embodiments of the invention described specifically herein. Such equivalents, modifications and variations are intended to be (or are) encompassed in the scope of the following claims.

1. Apparatus for distributing a solid, gel, powder or viscous test substance in an extraction fluid, the apparatus comprising:
(a) a flow cell for holding the test substance and having an inlet and an outlet;
(b) an extraction chamber located between said inlet and outlet comprising a convergent nozzle; and
(c) a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet;
characterized in that the apparatus further comprises a tortuous path flow control valve (TPV) located at the outlet and configured to permit flow of extraction fluid and extracted test substance but to prevent or retard passage of said test substance through the outlet.

2. The apparatus of claim 1 wherein the TPV is configured such that, in use, it increases the pressure differential across the flow cell.

3. The apparatus of claim 1 wherein the TPV is a labyrinth control valve.

4. The apparatus of claim 3 wherein the TPV is a simple labyrinth control valve.

5. The apparatus of claim 3 wherein the TPV is a branched labyrinth control valve.

6. The apparatus of claim 3 wherein the TPV is a reticulated labyrinth control valve.

7. The apparatus of claim 6 wherein the TPV comprises a plurality of notched cylindrical wedges disposed on a spindle along the longitudinal axis of the outlet.

8. The apparatus of claim 1 wherein the extraction chamber is configured to produce turbulent flow of extraction fluid and extracted test substance in the convergent nozzle.

9. The apparatus claim 8 wherein the extraction chamber comprises at least one, two, three or four grooves and/or ribs in or on its internal surface whereby, in use, the grooves and/or ribs produce turbulent flow of extraction fluid in the extraction chamber and around the test substance.

10. The apparatus of claim 9 wherein said grooves and/or ribs extend partly or fully from the inlet to the outlet.

11. The apparatus of claim 10 wherein said grooves and/or ribs extend partly or fully along the longitudinal wall of the convergent nozzle.

12. The apparatus of claim 1 further comprising an ultrasound generator for sonicating test substance in the flow cell.

13. The apparatus of claim 1 further comprising a collection valve for switching the flow of extraction fluid from a recirculating path to a collection port.

14. The apparatus of claim 13 wherein the flow to the collection port is via a filter.

15. The apparatus of claim 1 further comprising retaining means within the flow cell for partitioning fragmented test substance according to size, such that larger fragments are retained nearer the inlet while smaller fragments may accumulate nearer the outlet.

16. The apparatus of claim 15 wherein the retaining means comprises mesh or wire.

17. The apparatus of claim 1 further comprising a solid, gel, powder or viscous test substance located in the flow cell.

18. The apparatus of claim 17 further comprising extraction fluid surrounding the test substance.

19. A method for dissolving and/or suspending a solid, gel, powder or viscous test substance in an extraction fluid comprising introducing the test substance into the flow cell of an apparatus as defined in claim 1 and then pumping extraction fluid through the flow cell and over the test substance contained therein.

20. A process for producing an extracted test substance comprising the method of claim 19.

21. The method of claim 19 wherein the test substance is a pharmaceutical solid dose form.

22. The method of claim 19 wherein the test substance is selected from: (a) an environmental sample; (b) a cosmetic sample; (c) a herbal extract sample; (d) a laboratory reagent sample; (e) a food sample; (f) a nutraceutical sample; (g) a dietary supplement sample; (h) an agrochemical sample; (i) a veterinary product sample; (j) a fine chemical sample; (k) a waste sample (e.g. an environmental waste sample); (l) a tobacco sample; or (m) a stimulant composition sample.

23.-99. (canceled)
